(19) United States
(12) Patent Application Publication
(10) Pub. No.: US 2010/0226498 A1
(43) Pub. Date: Sep. 9, 2010

(54) Audio apparatus and audio processing method

(75) Inventors: Yasuyuki Kino, Tokyo (JP); Takeshi Momose, Saitama (JP); Tokihiko Sawashi, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/660,401

(22) Filed: Feb. 25, 2010

(30) Foreign Application Priority Data
Mar. 6, 2009 (JP) P2009-053593

(51) Int. Cl. H04R 5/00

(52) U.S. Cl. 381/1

(57) ABSTRACT

The present invention provides an audio apparatus including: a decoding device configured to decode results of channel-by-channel reproduction of a multichannel sound source made up of at least a left channel, a right channel, and a center channel, and to down-mix the decoded results of channel-by-channel reproduction in accordance with the number of speakers configured in a speaker system without a center speaker corresponding to the center channel; an audio processing device configured to perform predetermined audio processing on the decoded results having undergone the down-mixing by the decoding device, and to get the processed results output from the speaker system; and a control device configured to control the audio processing device.

### CROSS-REFERENCE TO RELATED APPLICATION

The present application claims priority from Japanese Patent Application No. JP JP 2009-053593 filed in the Japanese Patent Office on Mar. 6, 2009, the entire content of which is incorporated herein by reference.

### BACKGROUND OF THE INVENTION

1. Field of the Invention

The present invention relates to an audio apparatus and an audio processing method. More particularly, the invention relates to an audio apparatus and an audio processing method for illustratively allowing an in-car audio apparatus to reproduce and output multichannel (e.g., 5.1 channel) audio signals.

2. Description of the Related Art

Typically, when AV (Audio Visual) contents of movies or the like including a multichannel (e.g., 5.1 channel) audio contents are reproduced by a 5.1 channel speaker system, the sound from a particular channel may not be heard properly due to the conditions of the audio equipment in use, surrounding environment status, or recording level variations.

In that case, the speaker volume of the channel in question need only be turned up because the number of channels found in the audio contents corresponds to the number of speakers configured in the speaker system in use on a one-to-one basis.

However, not all users possess the 5.1 channel audio reproduction environment; there still exist numerous users not in possession of surround speakers or center speakers. In such cases, if the speaker system of the audio apparatus in question does not have a center speaker, the signal of the channel for the center speaker is assigned to the signals for other speakers through down-mixing, whereby all signals of the audio contents of interest are reproduced and output.

Specifically, as shown in FIG. 1, an ordinary car audio apparatus 1 reproduces from a disk-type recording medium 2 a sound source constituted by 5.1 channel audio contents D1 (made up of a left speaker channel signal component L, a right speaker channel signal component R, a center speaker channel signal component C, a left surround speaker channel signal component Ls, a right surround speaker channel signal content Rs, and a subwoofer channel signal component LFE). The audio contents D1 thus reproduced are forwarded to an audio decoder 4 of a DSP (Digital Signal Processor) 3.

Until it is attached to a car, the car audio apparatus 1 does not recognize a speaker system SS1 of that car (e.g., as a 5.1, 4.1, 4 or 2 channel configuration). The car audio apparatus 1 recognizes the configuration of the speaker system SS1 in response to operation buttons 13 being pressed by the user.

That is, the speaker system SS1 of the car may illustratively have a 4.1 channel configuration (with a left speaker 7, a right speaker 8, a left surround speaker 9, a right surround speaker 10, and a subwoofer 11). This configuration is recognized by a microcomputer 12 in response to the operation buttons 13 being pressed by the user.

The microcomputer 12 of the car audio apparatus 1 then notifies, by a control signal S1, the audio decoder 4 in the DSP (Digital Signal Processor) 3 that the onboard speaker system SS1 has the 4.1 channel configuration.

In turn, the audio decoder 4 down-mixes the 5.1 channel audio contents D1 into 4.1 channel contents to comply with the number of speakers of the speaker system SS1 in accordance with a predetermined method.

Specifically, the audio decoder 4 mixes the left speaker channel signal component L with the center speaker channel signal component C, and the right speaker channel signal component R with the center speaker channel signal component C. In this manner, the 5.1 channel audio contents D1 are down-mixed into the 4.1 channel audio contents.

That is, the audio decoder 4 sends to the audio postprocessor 5 audio data D2 constituted by a mixed channel signal component L+C (made up of the left speaker channel signal component L and center speaker channel signal component C), a mixed channel signal component R+C (composed of the right speaker channel signal component R and center speaker channel signal component C), the left surround speaker channel signal component Ls, right surround speaker channel signal component Rs, and subwoofer channel signal component LFE.

Given from the audio decoder 4 the audio data D2 (L+C, R+C, Ls, Rs, LFE) down-mixed to 4.1 channel data, the audio postprocessor 5 performs such processes as equalizer control and time alignment control on the received data D2. The audio data D4 thus processed is fed to a power amplifier 6.

The power amplifier 6 amplifies the audio data D2 (L+C, R+C, Ls, Rs, LFE) to a predetermined level. The amplified audio data D2 is eventually reproduced as a 4.1 channel sound output through the left speaker 7, right speaker 8, left surround speaker 9, right surround speaker 10, and subwoofer 11.

There have been proposed information apparatuses for down-mixing multitrack data into 2 channel or 5.1 channel audio data to be reproduced and output. One such information apparatus is disclosed illustratively in Japanese Patent Laid-Open No. 2005-70545.

### SUMMARY OF THE INVENTION

In the above-described car audio apparatus 1, the center speaker channel signal component C is assigned to the left speaker channel signal component L and to the right speaker channel signal component R through the down-mixing process. It may be thus impossible to amplify solely the center speaker channel signal component C.

As a result, the car audio apparatus 1 can only amplify the mixed channel signal component L+C and mixed channel signal component R+C subsequent to the down-mixing process. The problem remains that the volume of the center speaker channel signal component C may not be controlled singly.

The present invention has been made in view of the above circumstances and provides an audio apparatus and an audio processing method whereby, even if the number of channels found in a given sound source is larger than the number of speakers configured in the speaker system for reproducing the source, the reproduced volume of the channel for which the corresponding speaker does not exist can be controlled singly.

In carrying out the present invention and according to one embodiment thereof, there is provided an audio apparatus including: a decoding device configured to decode results of channel-by-channel reproduction of a multichannel sound source made up of at least a left channel, a right channel, and a center channel, and to down-mix the decoded results of channel-by-channel reproduction in accordance with the number of speakers configured in a speaker system without a center speaker corresponding to the center channel; an audio processing device configured to perform predetermined audio processing on the decoded results having undergone the down-mixing by the decoding device, and to get the processed results output from the speaker system; and a control device configured to control the audio processing device; wherein the control device causes the decoding device to decode the results of channel-by-channel reproduction of the sound source, without performing the down-mixing in accordance with the number of speakers configured in the speaker system; and the control device causes the audio processing device to gain-control within the sound source solely a center channel signal component corresponding to the center speaker not found in the speaker system, and to mix the gain-controlled center channel signal component with a left channel signal component and a right channel signal component corresponding to the left channel and the right channel respectively, thereby carrying out the down-mixing process for output through the speaker system.

According to another embodiment of the present invention, there is provided an audio processing method for use with a decoding device configured to decode results of channel-by-channel reproduction of a multichannel sound source made up of at least a left channel, a right channel, and a center channel, and to down-mix the decoded results of channel-by-channel reproduction in accordance with the number of speakers configured in a speaker system without a center speaker corresponding to the center channel; an audio processing device; and a control device; the audio processing method including the steps of: causing the control device to control the decoding device so as to decode the results of channel-by-channel reproduction of the sound source without performing the down-mixing in accordance with the number of speakers configured in a speaker system; and causing the control device to control the audio processing device so as to gain-control within the sound source solely a center channel signal component corresponding to the center speaker not found in the speaker system, and to mix the gain-controlled center channel signal component with a left channel signal component and a right channel signal component corresponding to the left channel and the right channel respectively, thereby carrying out the down-mixing process for output through the speaker system.

According to the above-outlined embodiments of the present invention, without getting the decoding device to down-mix the center channel signal component, the control device causes the audio processing device to amplify solely the center channel signal component and mix the amplified center channel signal component with the left channel signal component and right channel signal component in a down-mixing process. Thus even if the number of speakers configured in the speaker system is smaller than the number of channels found in the multichannel sound source, the center channel signal component corresponding to the center speaker not found in the speaker system can be gain-controlled before being output.

According to a further embodiment of the present invention, there is provided an audio apparatus including: a decoding device configured to decode results of channel-by-channel reproduction of a multichannel sound source and to down-mix the decoded results of channel-by-channel reproduction in accordance with the number of speakers configured in a speaker system; an audio processing device configured to perform predetermined audio processing on the decoded results having undergone the down-mixing by the decoding device, and to get the processed results output from the speaker system; and a control device configured to control the audio processing device; wherein the control device causes the decoding device to decode the results of channel-by-channel reproduction of the sound source, without performing the down-mixing in accordance with the number of speakers configured in the speaker system; and wherein the control device causes the audio processing device to gain-control within the sound source solely a particular channel signal component corresponding to a particular speaker not found in the speaker system, and to mix the gain-controlled particular channel signal component with the other channel signal components of the sound source, thereby carrying out the down-mixing process for output through the speaker system.

According to the embodiment of the present invention outlined immediately above, without getting the decoding device to down-mix the particular channel signal component corresponding to the speaker not found in the speaker system, the control device causes the audio processing device to amplify the particular channel signal component and then to mix the amplified particular channel signal component with the other channel signal components. Thus even if the number of speakers configured in the speaker system is smaller than the number of channels found in the multichannel sound source, the particular channel signal component corresponding to the particular speaker not found in the speaker system can be gain-controlled before being output.

As outlined above, the present invention provides an audio apparatus and an audio processing method whereby, without getting the decoding device to down-mix the center channel signal component, the audio processing device is caused to amplify solely the center channel signal component and mix the amplified center channel signal component with the left channel signal component and right channel signal component in a down-mixing process. Thus even if the number of speakers configured in the speaker system is smaller than the number of channels found in the multichannel sound source, the center channel signal component corresponding to the center speaker not found in the speaker system can be gain-controlled before being output. In other words, where the number of channels found in the sound source is larger than the number of speakers configured in the speaker system, the reproduced volume of the channel corresponding to a nonexistent speaker can be controlled.

The present invention also provides an audio apparatus whereby, without getting the decoding device to down-mix the particular channel signal component corresponding to the speaker not found in the speaker system, the audio processing device is caused to amplify the particular channel signal component and then to mix the amplified particular channel signal component with the other channel signal components. Thus even if the number of speakers configured in the speaker system is smaller than the number of channels found in the multichannel sound source, the particular channel signal component corresponding to the particular speaker not found in the speaker system can be gain-controlled before being output. In other words, where the number of channels found in the sound source is larger than the number of speakers configured in the speaker system, the reproduced volume of the channel corresponding to a nonexistent speaker can be controlled.

### BRIEF DESCRIPTION OF THE DRAWINGS

FIG. 1 is a schematic block diagram showing a circuit structure of an ordinary car audio apparatus;

FIG. 2 is a schematic perspective view showing an external structure of a car audio apparatus according to a first, a second and a third embodiment of the present invention;

FIG. 3 is a schematic block diagram showing a circuit structure of the car audio apparatus according to the first embodiment of the present invention;

FIG. 4 is a flowchart of steps constituting a center speaker component control procedure performed by the first embodiment;

FIGS. 5A, 5B, 5C and 5D are schematic views explanatory of sound function transitions;

FIGS. 6A, 6B, 6C and 6D are schematic views explanatory of the volume control of a center speaker component;

FIG. 7 is a schematic view explanatory of leaving center speaker component control mode and going back to sound function selection mode;

FIG. 8 is a schematic view explanatory of fine control of the center speaker component;

FIG. 9 is a schematic block diagram showing a circuit structure of the car audio apparatus according to the second embodiment;

FIG. 10 is a flowchart of steps constituting the center speaker component control procedure performed by the second embodiment;

FIG. 11 is a schematic block diagram showing a circuit structure of the car audio apparatus according to the third embodiment; and

FIG. 12 is a schematic block diagram of the car audio apparatus according to other variations of the present invention.

### DETAILED DESCRIPTION OF THE PREFERRED EMBODIMENTS

The preferred embodiments of the present invention will now be described below under the following headings:

1. First embodiment

2. Second embodiment

3. Third embodiment

4. Other variations

### 1. First Embodiment

### 1-1. External Structure of the Car Audio Apparatus

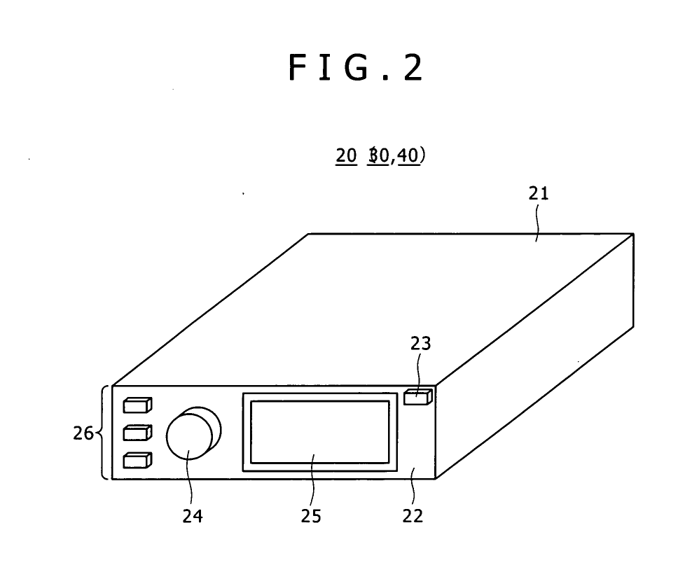

In FIG. 2, reference numeral 20 denotes a car audio apparatus for use as the first embodiment of the present invention. A rectangular enclosure 21 is embedded in the dashboard of the car. The car audio apparatus 20 has a front panel 22 of the enclosure 21 furnished with a power button 23, a rotary encoder 24 that can be rotated and pressed, a liquid crystal display (LCD) 25 for various display, and a group of operation buttons 26.

### 1-2. Circuit Structure of the Car Audio Apparatus

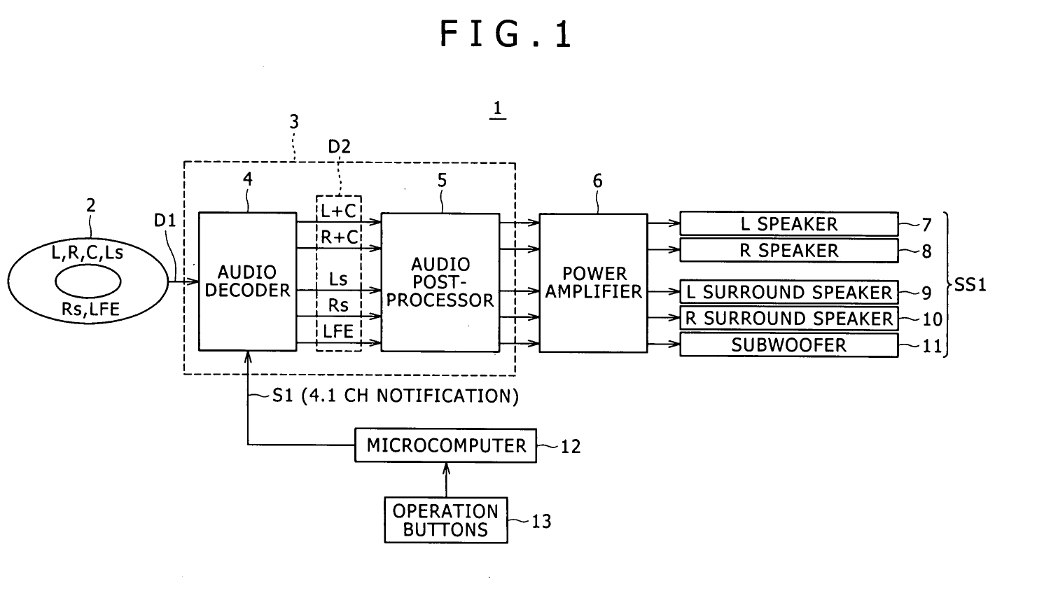

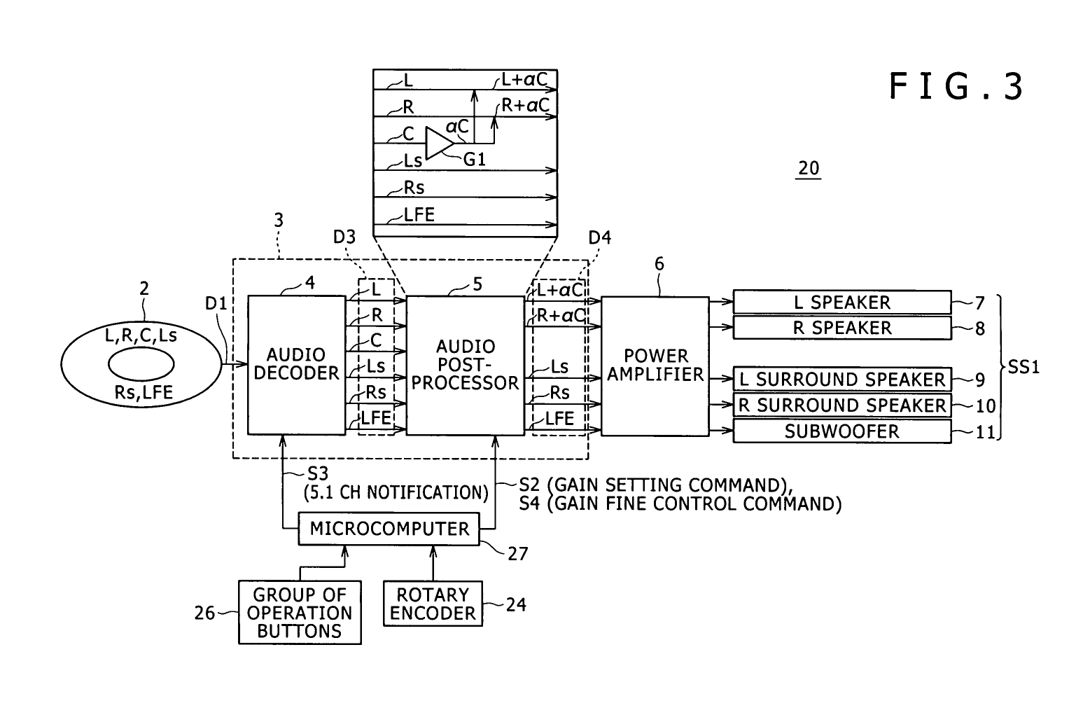

In FIGS. 1 and 3, like reference numerals designate like or corresponding parts. As shown in FIG. 3, the car audio apparatus 20 as a whole is controlled by a microcomputer (CPU) 27 reading basic programs from a ROM (Read Only Memory), not shown, into a RAM (Random Access Memory), not shown, for program execution.

Diverse functions of the car audio apparatus 20 are implemented by the microcomputer 27 reading various application programs from the ROM into the RAM and executing these application programs to carry out various processes.

The car audio apparatus 20 accommodates a disk-type recording medium 2 such as a DVD (Digital Versatile Disc) from which to reproduce 5.1 channel audio contents as a target sound source. Meanwhile, it is assumed that the car on which to mount the car audio apparatus 20 for sound reproduction and output is equipped with a 4.1 channel speaker system SS1.

That is, whereas the audio contents of the sound source have the 5.1 channel format, the speaker system SS1 by which the audio contents are to be reproduced and output has a 4.1 channel configuration made up of a left speaker 7, a right speaker 8, a left surround speaker 9, a right surround speaker 10, and a subwoofer 11, with no center speaker.

In practice, the microcomputer 27 of the car audio apparatus 20 causes a disk playing device, not shown, to reproduce data from the disk-type recording medium 2. In response to the user's rotating or pressing operations on a rotary encoder 24, the microcomputer 27 enters center speaker component control mode. In this mode, the microcomputer 27 carries out the following processes.

Whereas the microcomputer 27 of the car audio apparatus 20 should ordinarily notify an audio decoder 4 in a DSP 3 of a control signal S1 (FIG. 1) indicating correctly that the speaker system SS1 has the 4.1 channel configuration, the microcomputer 27 instead notifies the audio decoder 4 of a false control signal S3 indicating incorrectly that the speaker system SS1 has the 5.1 channel configuration.

In turn, the audio decoder 4 decodes the audio contents D1 of the 5.1 channel format reproduced from the disk-type recording medium 2 and, without performing a down-mixing process, sends to an audio postprocessor 5 the decoded contents as decoded audio data D3 in the 5.1 channel format (made up of a left speaker channel signal component L, a right speaker channel signal component R, a center speaker channel signal component C, a left surround speaker channel signal component Ls, a right surround speaker channel signal component Rs, and a subwoofer channel signal component LFE).

Since the onboard speaker system SS1 does not have a center speaker, the audio postprocessor 5 causes an amplifier circuit G1 to amplify the center speaker channel signal component C by a predetermined gain α (e.g., up 3 dB).

Meanwhile, the microcomputer 27 receives a gain setting command from the rotary encoder 24 being operated by the user, and outputs to the audio postprocessor 5 a control signal S2 representative of the gain setting command. This establishes the gain α for the amplifier circuit G1 beforehand.

The audio postprocessor 5 mixes the center speaker channel signal component αC amplified by the amplifier circuit G1 with the right speaker channel signal component L and right speaker channel signal component R. The mixing process generates a left speaker channel signal component L+αC and a right speaker channel signal component R+αC.

The audio postprocessor 5 then outputs to a power amplifier 6 audio data D4 constituted by the left speaker channel signal component L-αC, right speaker channel signal component R+αC, left surround speaker channel signal component Ls, right surround speaker channel signal component Rs, and subwoofer channel signal component LFE.

It should be noted that the audio postprocessor 5 sends the left surround speaker channel signal component Ls, right surround speaker channel signal component Rs, and subwoofer channel signal component LFE in an unmodified manner to the power amplifier 6.

The power amplifier 6 amplifies the left speaker channel signal component L-αC, right speaker channel signal component R+αC, left surround speaker channel signal component Ls, right surround speaker channel signal component Rs, and subwoofer channel signal component LFE to a predetermined level. The signal components thus amplified are output through the speaker system SS1 as a reproduced sound.

### 1-3. Center Speaker Component Control Routine

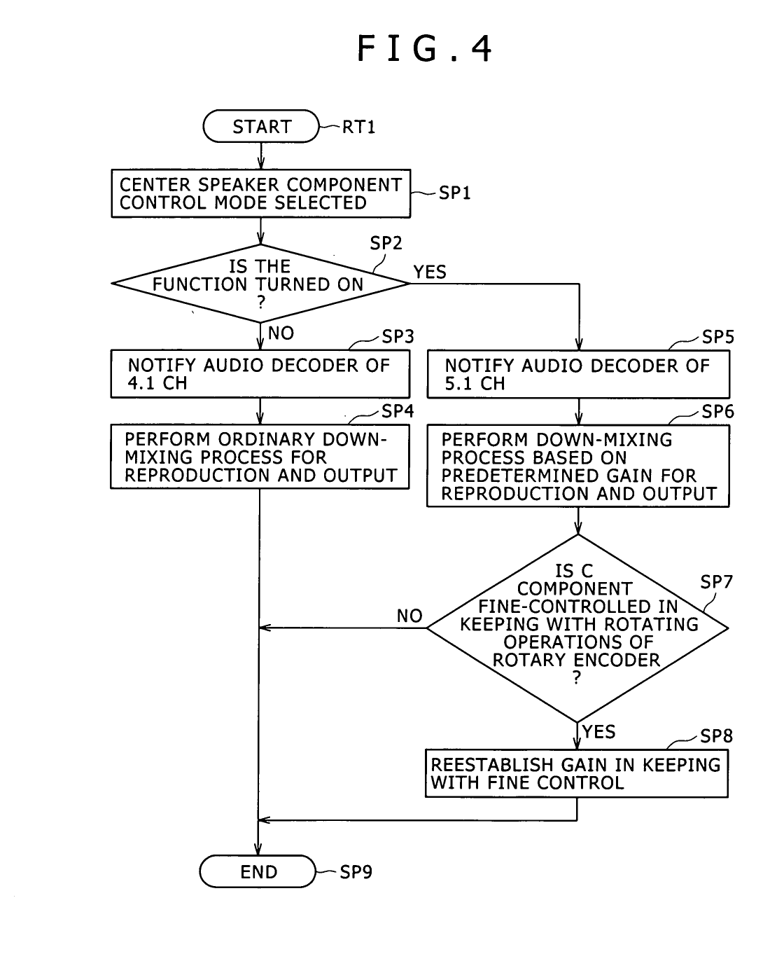

Described below in more detail with reference to FIG. 4 is a center speaker component control routine carried out by the car audio apparatus 20 in the above-mentioned center speaker component control mode.

Upon starting the routine RT1, the microcomputer 27 of the car audio apparatus 20 goes to step SP1. In step SP1, the microcomputer 27 waits for center speaker component control mode to be selected from among FM radio mode, equalizer control mode, speaker position control mode, and center speaker component control mode. When center speaker component control mode is selected, the microcomputer 27 goes to step SP2.

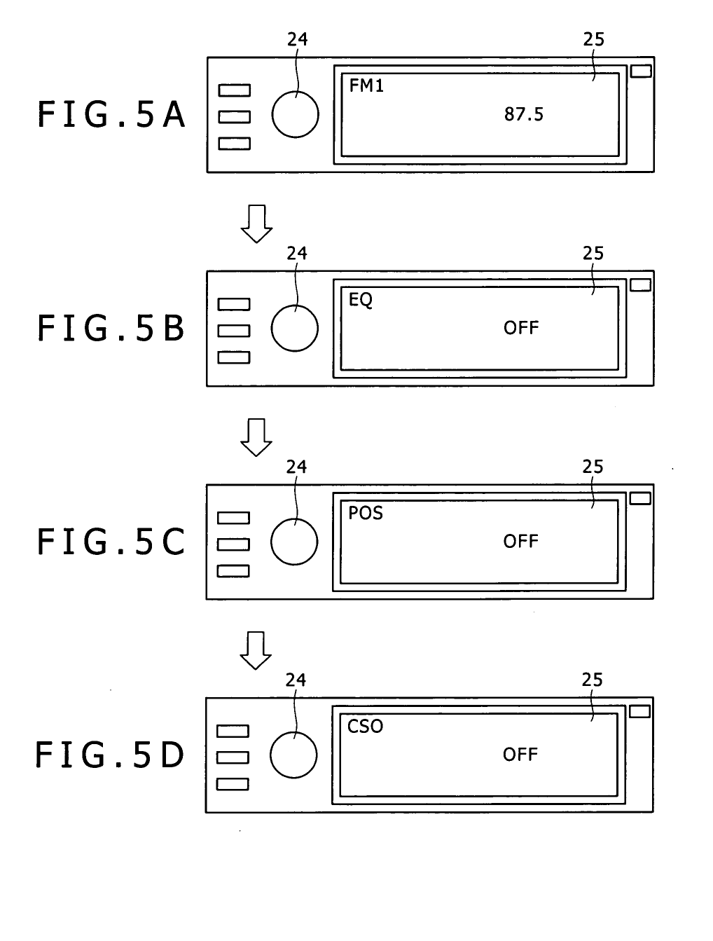

Specifically, when the rotary encoder 24 is pressed successively by the user, transitions are effected from FM radio mode (displayed as “FM1” on the LCD 25 shown in FIG. 5A) to equalizer control mode (displayed as “EQ” (equalizer) on the LCD 25 in FIG. 5B) to speaker position control mode (displayed as “POS” (position) on the LCD 25 in FIG. 5C) to center speaker component control mode (displayed as “CSO” (center speaker organizer) on the LCD 25 in FIG. 5D).

In step SP2, the microcomputer 27 of the car audio apparatus 20 checks to determine whether a center speaker component control function for amplifying the center speaker channel signal component C alone is turned on in the center speaker component control mode selected by the rotary encoder 24 being pressed.

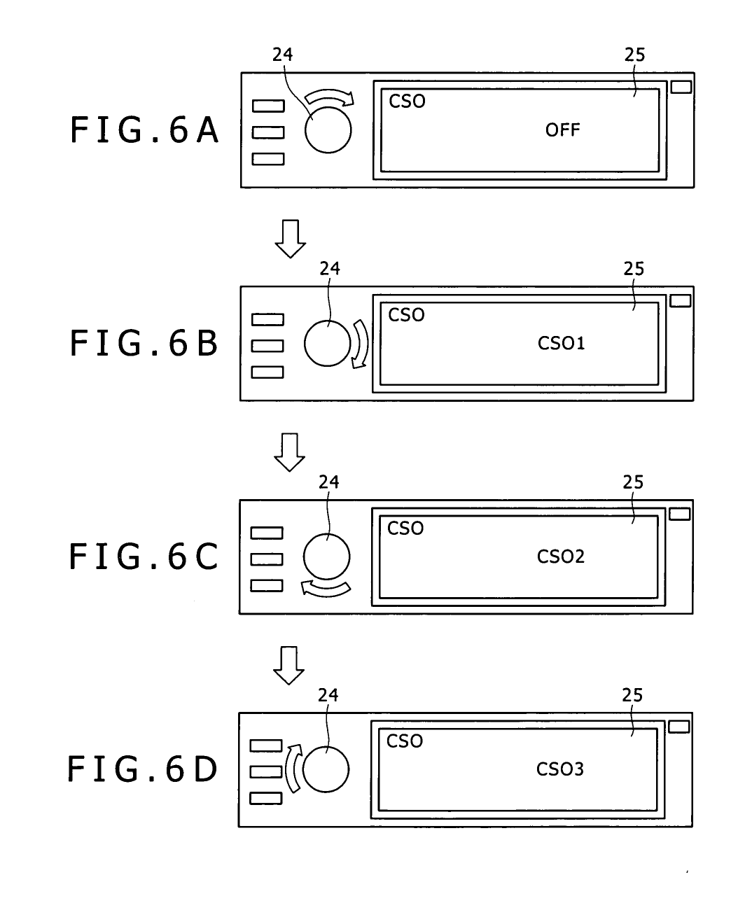

In that step, if the rotary encoder 24 is found rotated to the extreme counterclockwise position, the microcomputer 27 of the car audio apparatus 20 turns off the center speaker component control function, indicated as “CSO OFF” in FIG. 6A.

If the rotary encoder 24 is rotated away from the extreme counterclockwise position, the microcomputer 27 of the car audio apparatus 20 turns on the center speaker component control function indicated as “CSO” and raises progressively the gain α of the center speaker channel signal component C in proportion to how much the rotary encoder 24 is rotated, as shown FIGS. 6B through 6D.

Illustratively, in accordance with how much the rotary encoder 24 is rotated, the microcomputer 27 sets the gain α for the amplifier circuit G1 of the audio postprocessor 5 to “CSO1” (up 3 dB), “CSO2” (up 6 dB), or “CSO3” (up 12 dB).

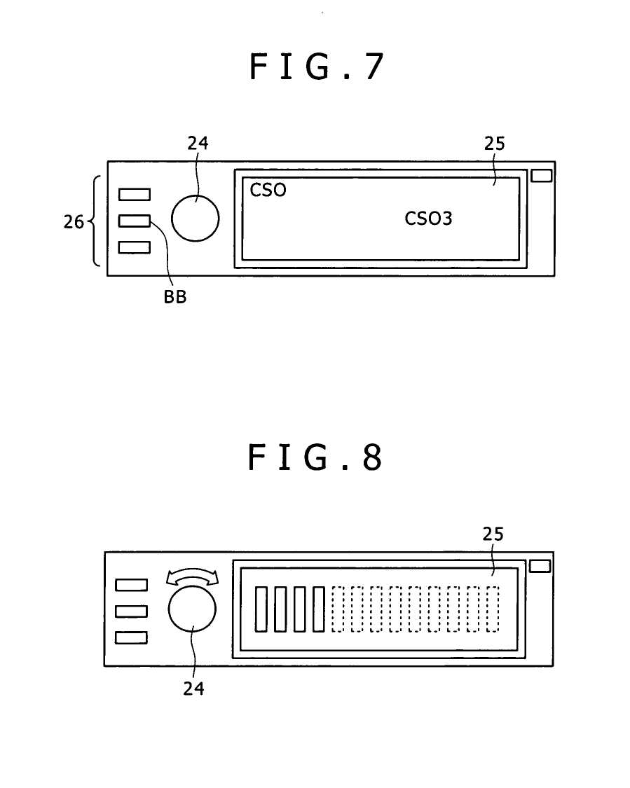

Thereafter, if a back button BB among the group of operation buttons 26 is pressed, the microcomputer 27 of the car audio apparatus 20 goes back to the function selection state (FIGS. 5A through 5D) in which to select FM radio mode, equalizer control mode, speaker position control mode, or center speaker component control mode, as shown in FIG. 7.

If the result of the check in step SP2 is negative, that means the rotary encoder 24 stays rotated to the extreme counterclockwise position and that the center speaker component control function remains turned off as shown in FIG. 6A (“CSO OFF”). In this case, the microcomputer 27 goes to step SP3.

In step SP3, with the center speaker component control function turned off, the microcomputer 27 of the car audio apparatus 20 notifies the audio decoder 4 in the DSP 3 of the control signal S1 (FIG. 1) saying that the onboard speaker system SS1 has the 4.1 channel configuration. The microcomputer 27 then goes to step SP4.

In step SP4, the microcomputer 27 of the car audio apparatus 20 down-mixes the audio contents D1 in the 5.1 channel format of the sound source to the 4.1 channel format commensurate with the number of speakers configured in the speaker system SS1. The down-mixed audio contents are fed to the audio postprocessor 5 and the power amplifier 6 before being reproduced and output by the speaker system SS1. From step SP4, the microcomputer 27 goes to step SP9 and terminates this routine.

In this case, the microcomputer 27 of the car audio apparatus 20 mixes the center speaker channel signal component C with the left speaker channel signal component L and right speaker channel signal component R, and outputs the down-mixed left speaker channel signal component L+C and right speaker channel signal component R+C.

On the other hand, if the result of the check in step SP2 is affirmative, that means the center speaker component control function is turned on and that the amplifier circuit G1 of the audio postprocessor 5 is set to the gain α of “CSO1,” “CSO2” or “CSO3” in keeping with how much the rotary encoder 24 is rotated. From step SP2, the microcomputer 27 goes to step SP5.

In step SP5, the microcomputer 27 of the car audio apparatus 20 notifies the audio decoder 4 of a false control signal S3 feigning that the speaker system SS1 has the 5.1 channel configuration despite the fact that the system SS1 actually has the 4.1 channel configuration. From step SP5, the microcomputer 27 goes to step SP6.

In step SP6, the microcomputer 27 of the car audio apparatus 20 sends the decoded contents from the audio decoder 4 to the audio postprocessor 5 as decoded audio data D3 in the 5.1 channel format without performing a down-mixing process.

The microcomputer 27 of the car audio apparatus 20 causes the amplifier circuit G1 of the audio postprocessor 5 to amplify the center speaker channel signal component C as per the gain α of “CSO1” set beforehand in keeping with how much the rotary encoder 24 is rotated, before mixing the amplified center speaker channel signal component C with the left speaker channel signal component L and right speaker channel signal component R.

The microcomputer 27 of the car audio apparatus 20 thus generates a left speaker channel signal component L+αC and a right speaker channel signal component R+αC in the down-mixing process. The microcomputer 27 eventually causes the reproduced contents to be output in the 4.1 channel format, before going to step SP7.

In step SP7, the microcomputer 27 of the car audio apparatus 20 checks to determine whether the rotary encoder 24 is further rotated in the reproduction state following the down-mixing process.

If the result of the check in step SP7 is negative, that means the rotary encoder 24 is no longer rotated in the reproduction state subsequent to the down-mixing process. In this case, the microcomputer 27 of the car audio apparatus 20 goes to step SP9 and terminates this routine.

If the result of the check in step SP7 is affirmative, that means a command to fine-control the volume of the center speaker channel signal component C in keeping with the rotating operation of the rotary encoder 24 is given. In this case, the microcomputer 27 goes to step SP8.

In step SP8, the microcomputer 27 of the car audio apparatus 20 reestablishes a raised or lowered gain α of “CSO1” for the amplifier circuit G1 of the audio postprocessor in accordance with the small amount of rotation of the rotary encoder 24. The microcomputer 27 then goes to step SP9 to terminate this routine.

In practice, upon receipt of a gain fine-control command reflecting the amount of the rotating operation of the rotary encoder 24, the microcomputer 27 (FIG. 3) of the car audio apparatus 20 outputs to the audio postprocessor 5 a control signal S4 representative of that gain fine-control command. This reestablishes a slightly raised or lowered gain α for the amplifier circuit G1.

In the case above, as shown in FIG. 8, the microcomputer 27 of the car audio apparatus 20 informs the user of how much the volume of the center speaker channel signal component C has changed in accordance with the small amount of operation of the rotary encoder 24, in the form of an eight-step gradation display on the LCD 25.

### 1-4. Operation and Effects

With the above-described structure in use, if the audio contents D1 of the sound source are in the 5.1 channel format while the speaker system SS1 for reproducing and outputting the audio contents D1 has the 4.1 channel configuration with no center speaker, the microcomputer 27 of the car audio apparatus 20 performs the following processes.

Whereas the speaker system SS1 of interest has in fact the 4.1 channel configuration, the microcomputer 27 of the car audio apparatus 20 notifies the audio decoder 4 in the DSP 3 of the false control signal S3 indicating incorrectly that the speaker system SS1 has the 5.1 channel configuration.

As a result, the audio decoder 4 in the DSP 3 decodes the audio contents D1 of the 5.1 channel format, without performing a down-mixing process, into decoded audio data D3 in the 5.1 channel format (made up of the left speaker channel signal component L, right speaker channel signal component R, center speaker channel signal component C, left surround speaker channel signal component Ls, right surround speaker channel signal content Rs, and subwoofer channel signal component LFE). The decoded audio data D3 thus acquired is forwarded to the audio postprocessor 5.

In turn, the audio postprocessor 5 causes the amplifier circuit G1 to amplify solely the center speaker channel signal component C by the predetermined gain α. The audio postprocessor 5 proceeds to mix the amplified center speaker channel signal component αC with the left speaker channel signal component L and right speaker channel signal component R in a down-mixing process.

In this manner, the microcomputer 27 of the car audio apparatus 20 causes the audio decoder 4 to decode the sound source data while leaving intact the number of channels found in the source regardless of the number of speakers configured in the speaker system SS1. Then, the microcomputer causes the audio postprocessor 5 to amplify the center speaker channel signal component C desired to be emphasized, before proceeding with the down-mixing process.

As a result, the car audio apparatus 20 can amplify solely the center speaker channel signal component C without amplifying the left speaker channel signal component L or right speaker channel signal component R containing relatively dominant sounds. This makes it possible to reproduce and output, say, speeches more clearly than before.

Also, in keeping with how much the rotary encoder 24 is rotated, the microcomputer 27 of the car audio apparatus 20 can set beforehand the gain α for the amplifier circuit G1 of the audio postprocessor 5 illustratively to “CSO1” (up 3 dB), “CSO2” (up 6 dB), or “CSO3” (up 12 dB), as shown in FIGS. 6B through 6D.

Furthermore, in accordance with the predetermined gain α of, say, “CSO1,” the microcomputer 27 amplifies the center speaker channel signal component C and performs the down-mixing process. While the decoded audio data in the 4.1 channel format is being eventually reproduced and output, the microcomputer 27 can fine-control and reestablish the gain α for the amplifier circuit G1 of the audio postprocessor 5 as per the small amount of rotation of the rotary encoder 24, as shown in FIG. 8.

As a result, the microcomputer 27 of the car audio apparatus 20 can fine-control the volume of the center speaker channel signal component C to the level desired by the user.

Where the above-described structure is in place, the car audio apparatus 20 can control the reproduced volume of solely the center speaker channel signal component C to the output level desired by the user, even if the audio contents D1 of the sound source are in the 5.1 channel format while the 4.1 channel speaker system SS1 for reproducing and outputting the audio contents D1 of interest does not have a center speaker.

### 2. Second Embodiment

### 2-1. External Structure of the Car Audio Apparatus

In FIG. 2, reference numeral 30 denotes a car audio apparatus for use as the second embodiment of the present invention. The car audio apparatus 30 is the same as the car audio apparatus 20 for use as the first embodiment and thus the external structure of the apparatus 30 will not be discussed further.

### 2-2. Circuit Structure of the Car Audio Apparatus

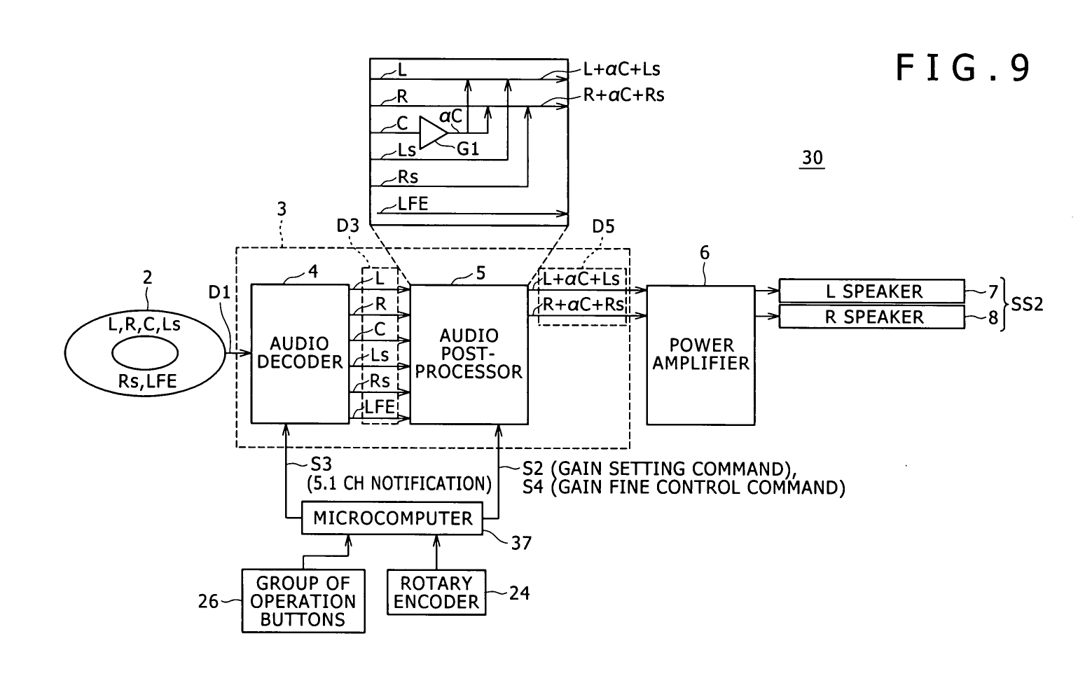

In FIGS. 3 and 9, like reference numerals designate like or corresponding parts. As shown in FIG. 9, the car audio apparatus 30 as a whole is controlled by a microcomputer (CPU) 37 reading basic programs from a ROM, not shown, into a RAM, not shown, for program execution.

Diverse functions of the car audio apparatus 30 are implemented by the microcomputer 37 reading various application programs from the ROM into the RAM and executing these application programs to carry out various processes.

The car audio apparatus 30 accommodates the disk-type recording medium 2 such as a DVD from which to reproduce 5.1 channel audio contents as a target sound source. Meanwhile, it is assumed that the car on which to mount the car audio apparatus 30 for sound reproduction and output is equipped with a 2 channel speaker system SS2.

That is, whereas the audio contents of the sound source are in the 5.1 channel format, the speaker system SS2 for reproducing and outputting the audio contents has the 2 channel configuration made up of a left speaker 7 and a right speaker 8. Not only the center speaker but also the left surround speaker, right surround speaker and subwoofer are absent.

In practice, the microcomputer 37 of the car audio apparatus 30 enters center speaker component control mode in response to the user's rotating and pressing operations on the rotary encoder 24. In center speaker component control mode, the microcomputer 37 initially performs the following processes.

Whereas the microcomputer 37 of the car audio apparatus 30 should ordinarily notify the audio decoder 4 in the DSP 3 of a control signal indicating correctly that the speaker system SS2 has the 2 channel configuration, the microcomputer 37 instead notifies the audio decoder 4 of the false control signal S3 indicating incorrectly that the speaker system SS2 has the 5.1 channel configuration.

In turn, the audio decoder 4 decodes the audio contents D1 of the 5.1 channel format reproduced from the disk-type recording medium 2 and, without performing a down-mixing process, sends to the audio postprocessor 5 the decoded contents as the decoded audio data D3 in the 5.1 channel format (made up of the left speaker channel signal component L, right speaker channel signal component R, center speaker channel signal component C, left surround speaker channel signal component Ls, right surround speaker channel signal component Rs, and subwoofer channel signal component LFE).

Since the onboard speaker system SS2 does not have a center speaker, the audio postprocessor 5 causes the amplifier circuit G1 to amplify the center speaker channel signal component C by a predetermined gain α (e.g., up 3 dB).

Meanwhile, the microcomputer 37 receives a gain setting command from the rotary encoder 24 being operated by the user, and outputs to the audio postprocessor 5 the control signal S2 representative of the gain setting command. This establishes the gain α for the amplifier circuit G1 beforehand.

The audio postprocessor 5 mixes the center speaker channel signal component αC amplified by the amplifier circuit G1 with the left speaker channel signal component L and right speaker channel signal component R. The mixing process generates the left speaker channel signal component L+αC and the right speaker channel signal component R+αC.

Since the onboard speaker system SS2 does not have a center speaker, a left surround speaker, a right surround speaker or a subwoofer, the audio postprocessor 5 mixes the left speaker channel signal component L+αC with the left surround speaker channel signal component Ls, and also mixes the right speaker channel signal component R+αC with the right surround speaker channel signal component Rs.

The audio postprocessor 5 thus generates a left speaker channel signal component L+αC+Ls and a right speaker channel signal component R+αC+Rs.

The audio postprocessor 5 then outputs to the power amplifier 6 audio data D5 constituted by the left speaker channel signal component L+αC+Ls and the right speaker channel signal component R+αC+Rs.

It should be noted that the audio postprocessor 5 does not output the subwoofer channel signal component LFE since the speaker system SS2 does not have a subwoofer.

The power amplifier 6 amplifies the left speaker channel signal component L+αC+Ls and the right speaker channel signal component R+αC+Rs to a predetermined level. The signal components thus amplified are eventually output as a 2 channel reproduced sound through the left speaker 7 and right speaker 8 of the speaker system SS2.

### 2-3. Center Speaker Component Control Routine

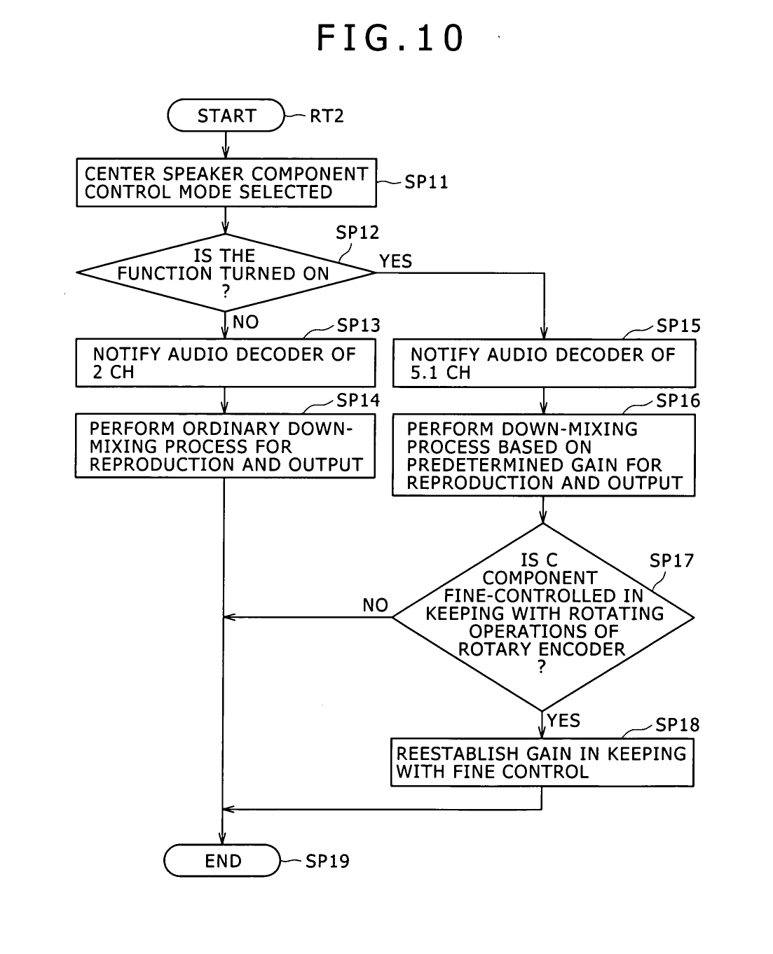

Described below in more detail with reference to FIG. 10 is a center speaker component control routine carried out by the car audio apparatus 30 in the above-mentioned center speaker component control mode.

Upon starting the routine RT2, the microcomputer 37 of the car audio apparatus 30 goes to step SP11. In step SP11, the microcomputer 37 waits for center speaker component control mode to be selected from among FM radio mode, equalizer control mode, speaker position control mode, and center speaker component control mode shown in FIGS. 5A through 5D. When center speaker component control mode is selected, the microcomputer 37 goes to step SP12.

In step SP12, the microcomputer 37 of the car audio apparatus 30 checks to determine whether the center speaker component control function for amplifying the center speaker channel signal component C alone is turned on in the center speaker component control mode selected by the rotary encoder 24 being pressed.

If the result of the check in step SP12 is negative, that means the rotary encoder 24 stays rotated to the extreme counterclockwise position and that the center speaker component control function remains turned off as shown in FIG. 6A (“CSO OFF”). In this case, the microcomputer 37 goes to step SP13.

In step SP13, with the center speaker component control function turned off, the microcomputer 37 of the car audio apparatus 30 notifies the audio decoder 4 in the DSP 3 of the control signal saying that the onboard speaker system SS2 has the 2 channel configuration. The microcomputer 37 then goes to step SP14.

In step SP14, the microcomputer 37 of the car audio apparatus 30 down-mixes the audio contents D1 in the 5.1 channel format of the sound source into the 2 channel format commensurate with the number of speakers configured in the speaker system SS2. The down-mixed audio contents are fed to the power amplifier 6 before being reproduced and output by the speaker system SS2. From step SP14, the microcomputer 37 goes to step SP19 and terminates this routine.

In this case, the audio decoder 4 mixes the center speaker channel signal component C with the left speaker channel signal component L and left surround speaker channel signal component Ls, and also mixes the center speaker channel signal component C with the right speaker channel signal component R and right surround speaker channel signal component Rs.

The audio decoder 4 then outputs the down-mixed left speaker channel signal component L+C+Ls and right speaker channel signal component R+C+Rs which in turn are output from the left speaker 7 and right speaker 8 of the speaker system SS2.

On the other hand, if the result of the check in step SP12 is affirmative, that means the center speaker component control function is turned on and that the amplifier circuit G1 of the audio postprocessor 5 is set to the gain α of “CSO1,” “CSO2” or “CSO3” in keeping with how much the rotary encoder 24 is rotated. From step SP12, the microcomputer 37 goes to step SP15.

In step SP15, the microcomputer 37 of the car audio apparatus 30 notifies the audio decoder 4 of the false control signal S3 feigning that the speaker system SS2 has the 5.1 channel configuration despite the fact that the system SS2 actually has the 2 channel configuration. From step SP15, the microcomputer 37 goes to step SP16.

In step SP16, the microcomputer 37 of the car audio apparatus 30 sends the decoded contents from the audio decoder 4 to the audio postprocessor 5 as the decoded audio data D3 in the 5.1 channel format without performing a down-mixing process.

The microcomputer 37 of the car audio apparatus 30 causes the amplifier circuit G1 of the audio postprocessor 5 to amplify the center speaker channel signal component C as per the gain α of “CSO1” set beforehand in keeping with how much the rotary encoder 24 is rotated.

Thereafter, the microcomputer 37 of the car audio apparatus 30 mixes the center speaker channel signal component αC amplified by the amplifier circuit G1 with the left speaker channel signal component L and left surround speaker channel signal component Ls, and also mixes the center speaker channel signal component αC with the right speaker channel signal component R and right surround speaker channel signal component Rs.

The microcomputer 37 of the car audio apparatus 30 thus generates a left speaker channel signal component L+αC+Ls and a right speaker channel signal component R+αC+Rs in the down-mixing process. The microcomputer 37 eventually causes the reproduced contents to be output in the 2 channel format, before going to step SP17.

In step SP17, the microcomputer 37 of the car audio apparatus 30 checks to determine whether the rotary encoder 24 is further rotated in the reproduction state following the down-mixing process.

If the result of the check in step SP17 is negative, that means the rotary encoder 24 is no longer rotated in the reproduction state subsequent to the down-mixing process. In this case, the microcomputer 37 of the car audio apparatus 30 goes to step SP19 and terminates this routine.

If the result of the check in step SP17 is affirmative, that means a command to fine-control the volume of the center speaker channel signal component C in keeping with the rotating operation of the rotary encoder 24 is given. In this case, the microcomputer 37 goes to step SP18.

In step SP18, the microcomputer 37 of the car audio apparatus 30 reestablishes a raised or lowered gain α of “CSO1” for the amplifier circuit G1 of the audio postprocessor in accordance with the small amount of rotation of the rotary encoder 24. The microcomputer 37 then goes to step SP19 to terminate this routine.

In practice, upon receipt of a gain fine-control command reflecting the amount of the rotating operation of the rotary encoder 24, the microcomputer 37 (FIG. 3) of the car audio apparatus 30 outputs to the audio postprocessor 5 the control signal S4 representative of that gain fine-control command. This reestablishes a slightly raised or lowered gain α for the amplifier circuit G1.

### 2-4. Operation and Effects

With the above-described structure in use, if the audio contents D1 of the sound source are in the 5.1 channel format while the speaker system SS2 for reproducing and outputting the audio contents D1 has the 2 channel configuration that does not include a center speaker, a left surround speaker or a right surround speaker, the microcomputer 37 of the car audio apparatus 30 performs the following processes.

Whereas the speaker system SS2 of interest has in fact the 2 channel configuration, the microcomputer 37 of the car audio apparatus 30 notifies the audio decoder 4 in the DSP 3 of the false control signal S3 indicating incorrectly that the speaker system SS2 has the 5.1 channel configuration.

As a result, the audio decoder 4 in the DSP 3 decodes the audio contents D1 of the 5.1 channel format, without performing a down-mixing process, into decoded audio data D3 in the 5.1 channel format. The decoded audio data D3 thus acquired is forwarded to the audio postprocessor 5.

In turn, the audio postprocessor 5 causes the amplifier circuit G1 to amplify solely the center speaker channel signal component C by the predetermined gain α. The audio postprocessor 5 proceeds to mix the amplified center speaker channel signal component αC with the left speaker channel signal component L and left surround speaker channel signal component Ls, and also mix the amplified center speaker channel signal component αC with the right speaker channel signal component R and right surround speaker channel signal component Rs in a down-mixing process.

In this manner, the microcomputer 37 of the car audio apparatus 30 causes the audio decoder 4 to decode the sound source data while leaving intact the number of channels found in the source regardless of the number of speakers configured in the speaker system SS2. Then the microcomputer causes the audio postprocessor 5 to amplify the center speaker channel signal component C desired to be emphasized, before proceeding with the down-mixing process.

As a result, the car audio apparatus 30 can amplify solely the center speaker channel signal component C without amplifying the left speaker channel signal component L or right speaker channel signal component R containing relatively dominant sounds. This makes it possible to reproduce and output, say, speeches more clearly than before.

In this case, the car audio apparatus 30 down-mixes the left surround speaker channel signal component Ls and right surround speaker channel signal component Rs. This enables the 2 channel speaker system SS2 to output eventually the kind of reproduced sound appreciably close to the original sound source.

Also, in keeping with how much the rotary encoder 24 is rotated, the microcomputer 37 of the car audio apparatus 30 can set beforehand the gain α for the amplifier circuit G1 of the audio postprocessor 5 illustratively to “CSO1” (up 3 dB), “CSO2” (up 6 dB), or “CSO3” (up 12 dB), as shown in FIGS. 6B through 6D.

Furthermore, in accordance with the predetermined gain α of, say, “CSO1,” the microcomputer 37 amplifies the center speaker channel signal component C and performs the down-mixing process. While the decoded audio data in the 2 channel format is being eventually reproduced and output, the microcomputer 37 can fine-control and reestablish the gain α for the amplifier circuit G1 of the audio postprocessor in keeping with the small amount of rotation of the rotary encoder 24, as shown in FIG. 8.

As a result, the microcomputer 37 of the car audio apparatus 30 can fine-control the volume of the center speaker channel signal component C to the level desired by the user.

Where the above-described structure is in place, the car audio apparatus 30 can control the reproduced volume of solely the center speaker channel signal component C to the output level desired by the user, even if the audio contents D1 of the sound source are in the 5.1 channel format while the channel speaker system SS2 for reproducing and outputting the audio contents D1 of interest does not have a center speaker, a left surround speaker, a right surround speaker or a subwoofer.

### 3. Third Embodiment

### 3-1. External Structure of the Car Audio Apparatus

In FIG. 2, reference numeral 40 denotes a car audio apparatus for use as the third embodiment of the present invention. The car audio apparatus 40 is the same as the car audio apparatus 20 for use as the first embodiment and thus the external structure of the apparatus 40 will not be discussed further.

### 3-2. Circuit Structure of the Car Audio Apparatus

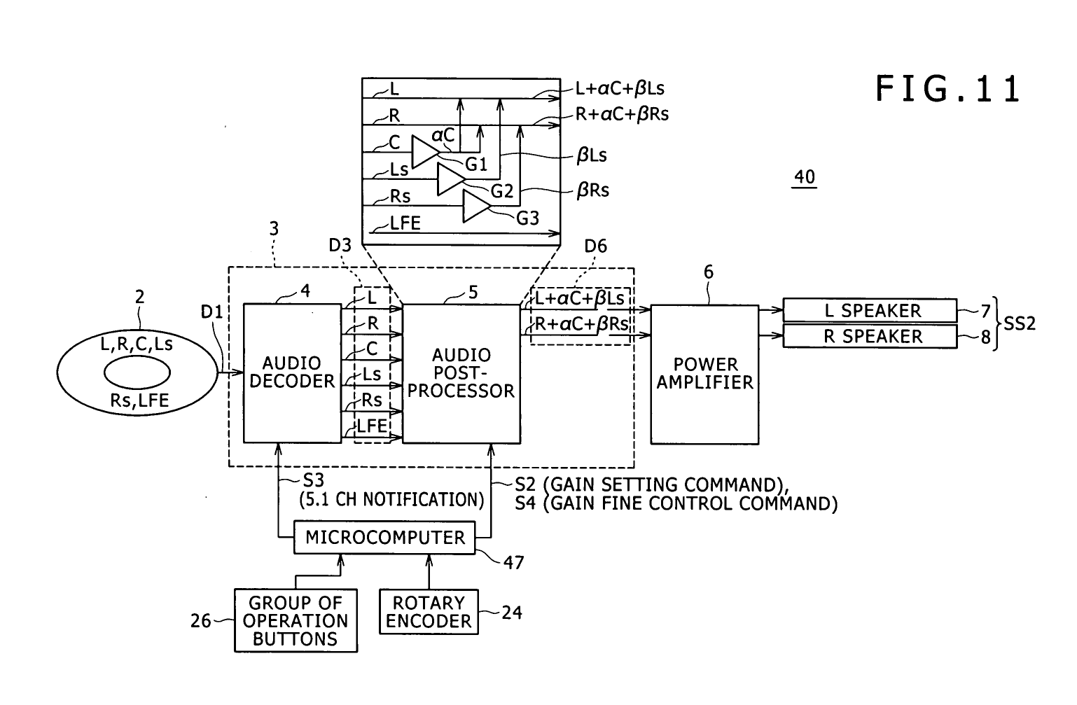

In FIGS. 3 and 11, like reference numerals designate like or corresponding parts. As shown in FIG. 11, the car audio apparatus 40 as a whole is controlled by a microcomputer (CPU) 47 reading basic programs from a ROM, not shown, into a RAM, not shown, for program execution.

Diverse functions of the car audio apparatus 40 are implemented by the microcomputer 47 reading various application programs from the ROM into the RAM and executing these application programs to carry out various processes.

The car audio apparatus 40 accommodates the disk-type recording medium 2 such as a DVD from which to reproduce 5.1 channel audio contents as a target sound source. Meanwhile, as with the car audio apparatus 30 of the second embodiment, it is assumed that the car on which to mount the car audio apparatus 40 for sound reproduction and output is equipped with the 2 channel speaker system SS2.

That is, whereas the audio contents of the sound source are in the 5.1 channel format, the speaker system SS2 for reproducing and outputting the audio contents has the 2 channel configuration made up of the left speaker 7 and right speaker 8.

In practice, the microcomputer 47 of the car audio apparatus 40 enters center speaker component control mode in response to the user's rotating and pressing operations on the rotary encoder 24. In center speaker component control mode, the microcomputer 47 initially performs the following processes.

Whereas the microcomputer 47 of the car audio apparatus 40 should ordinarily notify the audio decoder 4 in the DSP 3 of a control signal indicating correctly that the speaker system SS2 has the 2 channel configuration, the microcomputer 47 instead notifies the audio decoder 4 of the false control signal S3 indicating incorrectly that the speaker system SS2 has the 5.1 channel configuration.

In turn, the audio decoder 4 decodes the audio contents D1 of the 5.1 channel format reproduced from the disk-type recording medium 2 and, without performing a down-mixing process, sends to the audio postprocessor 5 the decoded contents as the decoded audio data D3 in the 5.1 channel format.

Since the onboard speaker system SS2 does not have a center speaker, the audio postprocessor 5 causes the amplifier circuit G1 to amplify the center speaker channel signal component C by a predetermined gain α (e.g., up 3 dB).

Furthermore, whereas the onboard speaker system SS2 does not have a left surround speaker and a right surround speaker, the audio postprocessor 5 causes amplifier circuits G2 and G3 to amplify the left surround speaker channel signal component Ls and right surround speaker channel signal component Rs, respectively, by a predetermined gain β (e.g., up 3 dB).

Meanwhile, the microcomputer 47 receives a gain setting command from the rotary encoder 24 being operated by the user, and outputs to the audio postprocessor 5 the control signal S2 representative of the gain setting command. This establishes the gain α for the amplifier circuit G1 and the gain β for the amplifier circuits G2 and G3 beforehand.

The audio postprocessor 5 mixes the center speaker channel signal component αC amplified by the amplifier circuit G1 with the left speaker channel signal component L and right speaker channel signal component R. The mixing process generates the left speaker channel signal component L+αC and the right speaker channel signal component R+αC.

Also, the audio postprocessor 5 mixes the left surround speaker channel signal component βLs amplified by the amplifier circuit G2 with the left speaker channel signal component L+αC to generate a left speaker channel signal component L+αC+βLs.

Likewise, the audio postprocessor 5 mixes the right surround speaker channel signal component βRs amplified by the amplifier circuit G3 with the right speaker channel signal component R+αC to generate a right speaker channel signal component R+αC+βRs.

The audio postprocessor 5 then outputs to the power amplifier 6 audio data D6 constituted by the left speaker channel signal component L+αC+βLs and right speaker channel signal component R+αC+βRs.

It should be noted that the audio postprocessor 5 does not output the subwoofer channel signal component LFE since the speaker system SS2 does not have a subwoofer.

The power amplifier 6 amplifies the left speaker channel signal component L+αC+βLs and right speaker channel signal component R+αC+βRs to a predetermined level. The signal components thus amplified are eventually output as a 2 channel reproduced sound through the left speaker 7 and right speaker 8 of the speaker system SS2.

### 3-3. Center Speaker Component Control Routine

The center speaker component control routine performed by the car audio apparatus 40 in the above-mentioned center speaker component control mode is basically the same as the center speaker component control routine shown as the routine RT2 in FIG. 10 and carried out by the car audio apparatus 30, and thus the routine will not be discussed further.

### 3-4. Operation and Effects

With the above-described structure in use, whereas the speaker system SS2 of interest has in fact the 2 channel configuration, the microcomputer 47 of the car audio apparatus notifies the audio decoder 4 in the DSP 3 of the false control signal S3 indicating incorrectly that the speaker system SS2 has the 5.1 channel configuration.

As a result, the audio decoder 4 in the DSP 3 decodes the audio contents D1 of the 5.1 channel format, without performing a down-mixing process, into decoded audio data D3 in the 5.1 channel format. The decoded audio data D3 thus acquired is forwarded to the audio postprocessor 5.

In turn, the audio postprocessor 5 causes the amplifier circuit G1 to amplify the center speaker channel signal component C by the predetermined gain α. Also, the audio postprocessor 5 causes the amplifier circuits G2 and G3 to amplify the left surround speaker channel signal component Ls and right surround speaker channel signal component Rs by the predetermined gain β.

The audio postprocessor 5 proceeds to mix the center speaker channel signal component αC amplified by the amplifier circuit G1 with the left surround speaker channel signal component βLs and right surround speaker channel signal component βRs amplified by the amplifier circuits G2 and G3, and also with left speaker channel signal component L and left surround speaker channel signal component Ls in a down-mixing process.

In this manner, the microcomputer 47 of the car audio apparatus 40 causes the audio decoder 4 to decode the sound source data while leaving intact the number of channels found in the source regardless of the number of speakers configured in the speaker system SS2. Then, the microcomputer 47 causes the audio postprocessor 5 to amplify the center speaker channel signal component C, left surround speaker channel signal component Ls, and right surround speaker channel signal component Rs desired to be emphasized, before proceeding with the down-mixing process.

As a result, the car audio apparatus 40 can amplify the center speaker channel signal component C, left surround speaker channel signal component Ls, and right surround speaker channel signal component Rs without amplifying the left speaker channel signal component L or right speaker channel signal component R containing relatively dominant sounds. This makes it possible to increase the volume of, say, speeches for a clearer comprehension of their contents and to provide better ambience enhancement by raising the volume of surround sounds.

Also, in keeping with how much the rotary encoder 24 is rotated, the microcomputer 47 of the car audio apparatus 40 can set beforehand the gain α for the amplifier circuit G1 of the audio postprocessor 5 and the gain β for the amplifier circuits G2 and G3 illustratively to “CSO1” (up 3 dB), “CSO2” (up 6 dB), or “CSO3” (up 12 dB), as shown in FIGS. 6B through 6D.

Furthermore, in accordance with the predetermined gains α and β of, say, “CSO1,” the microcomputer 47 amplifies the center speaker channel signal component C, left surround speaker channel signal component Ls, and right surround speaker channel signal component Rs and performs the down-mixing process. While the decoded audio data in the 2 channel format is being eventually reproduced and output, the microcomputer 47 can fine-control and reestablish the gains α and β for the amplifier circuits G1, G2 and G3 of the audio postprocessor 5 in keeping with the small amount of rotation of the rotary encoder 24, as shown in FIG. 8.

As a result, the microcomputer 47 of the car audio apparatus 40 can fine-control the volume of the center speaker channel signal component C, left surround speaker channel signal component Ls, and right surround speaker channel signal component Rs to the level desired by the user.

Where the above-described structure is in place, the car audio apparatus 40 can control the reproduced volume of the center speaker channel signal component C, left surround speaker channel signal component Ls, and right surround speaker channel signal component Rs to the output level desired by the user, even if the audio contents D1 of the sound source are in the 5.1 channel format while the 2 channel speaker system SS2 for reproducing and outputting the audio contents D1 of interest does not have a center speaker, a left surround speaker, a right surround speaker or a subwoofer.

### 4. Other Variations

According to the first through the third embodiments above of the present invention, the gain α is set illustratively to “CSO1” (up 3 dB), “CSO2” (up 6 dB), or “CSO3” (up 12 dB) in keeping with how much the rotary encoder 24 is rotated.

However, this is not limitative of the present invention. Instead of being amplified, the gain may be attenuated by 3 dB, 6 dB or 12 dB in accordance with how much the rotary encoder 24 is rotated. It should be noted that these values are only examples and are not limitative of the invention.

According to the first through the third embodiments of the invention discussed above, the audio decoder 4 in the DSP 3 and the amplifier circuit G1 in the audio postprocessor 5 are used digitally to carry out the center speaker component control routine described above.

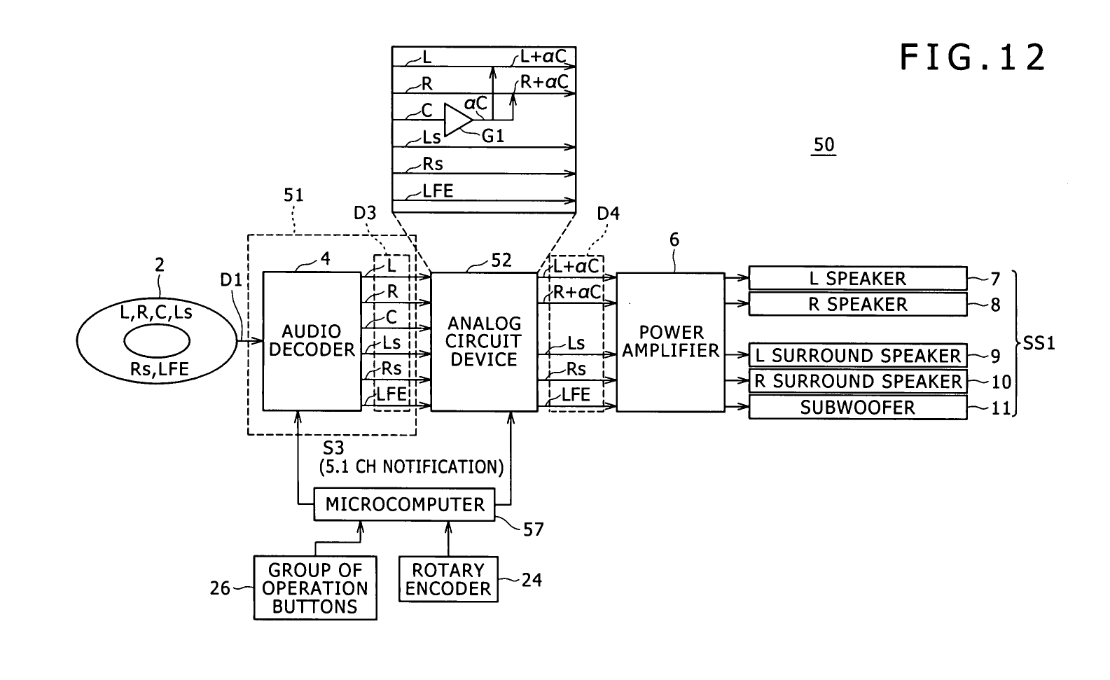

Alternatively, as shown in FIG. 12 (where like reference numerals designate like or corresponding parts in FIG. 3), the above-described setup with the audio postprocessor 5 in the DSP 3 may be replaced with a car audio apparatus 50 constituted by a DSP 51 containing an audio decoder 4 alone and by an analog circuit device 52 having an amplifier circuit G1 made of analog circuits, the apparatus 50 carrying out the center speaker component control routine. In this case, the gain α of the amplifier circuit G1 is fixed so that the volume level of the center speaker channel signal component C may not be controlled.

Also according to the first through the third embodiments of the present invention described above, there is no center speaker in the speaker system so that the volume level of the center speaker channel signal component C is controlled.

Alternatively, where neither the left surround speaker nor the right surround speaker is provided, the volume levels of the left surround speaker channel signal component Ls and right surround speaker channel signal component Rs may be arranged to be controlled.

The point is that solely the speaker channel signal component corresponding to a nonexistent speaker is amplified by the audio postprocessor 5 before being down-mixed with the channel signal components of the other speakers. Any channel may be subject to gain control.

Furthermore, according to the above-described first through third embodiments of the present invention, the inventive car audio apparatus 20, 30 or 40 is constituted by the decoding device composed of the audio decoder 4, by the audio processing device formed by the audio postprocessor 5, and by the control device made up of the microcomputer 27, 37 or 47. Alternatively, the audio apparatus of the present invention may be constituted by a decoding device, an audio processing device and a control device structured in ways other than those discussed above.

The audio apparatus and audio processing method of the present invention can be applied not only to car audio apparatuses but also to home audio equipment, personal computers, car navigation systems, and other appliances.

It should be understood by those skilled in the art that various modifications, combinations, sub-combinations and alterations may occur depending on design requirements and other factor in so far as they are within the scope of the appended claims or the equivalents thereof.

What is claimed is:

1. An audio apparatus comprising:
decoding means for decoding results of channel-by-channel reproduction of a multichannel sound source made up of at least a left channel, a right channel, and a center channel, and down-mixing the decoded results of channel-by-channel reproduction in accordance with the number of speakers configured in a speaker system without a center speaker corresponding to said center channel;
audio processing means for performing predetermined audio processing on said decoded results having undergone the down-mixing by said decoding means, and getting the processed results output from said speaker system; and
control means for controlling said audio processing means;
wherein said control means causes said decoding means to decode said results of channel-by-channel reproduction of the sound source, without performing said down-mixing in accordance with the number of speakers configured in said speaker system; and
said control means causes said audio processing means to gain-control within said sound source solely a center channel signal component corresponding to said center speaker not found in said speaker system, and to mix the gain-controlled center channel signal component with a left channel signal component and a right channel signal component corresponding to said left channel and said right channel respectively, carrying out the down-mixing process for output through said speaker system.

2. The audio apparatus according to claim 1, wherein, besides causing said audio processing means to mix the gain-controlled center channel signal component with said left channel signal component and said right channel signal component, said control means further causes said audio processing means to mix a left surround channel signal component corresponding to a left surround speaker not found in said speaker system with said left channel signal component, and a right surround channel signal component corresponding to a right surround speaker not found in said speaker system with said right channel signal component, carrying out the down-mixing process for output through said speaker system.

3. The audio apparatus according to claim 2, wherein, besides causing said audio processing means to mix said gain-controlled center channel signal component with said left channel signal component and said right channel signal component, said control means further causes said audio processing means to gain-control said left surround channel signal component corresponding to said left surround speaker not found in said speaker system before mixing the gain-controlled left surround channel signal component with said left channel signal component, and to gain-control said right surround channel signal component corresponding to said right surround speaker not found in said speaker system before mixing the gain-controlled right surround channel signal component with said right channel signal component, carrying out the down-mixing process for output through said speaker system.

4. An audio processing method for use with decoding means for decoding results of channel-by-channel reproduction of a multichannel sound source made up of at least a left channel, a right channel, and a center channel, and down-mixing the decoded results of channel-by-channel reproduction in accordance with the number of speakers configured in a speaker system without a center speaker corresponding to said center channel, audio processing means, and control means, said audio processing method comprising the steps of:
causing said control means to control said decoding means so as to decode said results of channel-by-channel reproduction of the sound source without performing the down-mixing in accordance with the number of speakers configured in a speaker system; and
causing said control means to control said audio processing means so as to gain-control within said sound source solely a center channel signal component corresponding to said center speaker not found in said speaker system, and to mix the gain-controlled center channel signal component with a left channel signal component and a right channel signal component corresponding to said left channel and said right channel respectively, carrying out the down-mixing process for output through said speaker system.

5. An audio apparatus comprising:
decoding means for decoding results of channel-by-channel reproduction of a multichannel sound source and down-mixing the decoded results of channel-by-channel reproduction in accordance with the number of speakers configured in a speaker system;
audio processing means for performing predetermined audio processing on said decoded results having undergone the down-mixing by said decoding means, and getting the processed results output from said speaker system; and
control means for controlling said audio processing means;
wherein said control means causes said decoding means to decode said results of channel-by-channel reproduction of the sound source, without performing said down-mixing in accordance with the number of speakers configured in said speaker system; and
said control means causes said audio processing means to gain-control within said sound source solely a particular channel signal component corresponding to a particular speaker not found in said speaker system, and to mix the gain-controlled particular channel signal component with the other channel signal components of said sound source, carrying out the down-mixing process for output through said speaker system.

6. An audio apparatus comprising:
a decoding device configured to decode results of channel-by-channel reproduction of a multichannel sound source made up of at least a left channel, a right channel, and a center channel, and to down-mix the decoded results of channel-by-channel reproduction in accordance with the number of speakers configured in a speaker system without a center speaker corresponding to said center channel;
an audio processing device configured to perform predetermined audio processing on said decoded results having undergone the down-mixing by said decoding device, and to get the processed results output from said speaker system; and
a control device configured to control said audio processing device;
wherein said control device causes said decoding device to decode said results of channel-by-channel reproduction of the sound source, without performing said down-mixing in accordance with the number of speakers configured in said speaker system; and
said control device causes said audio processing device to gain-control within said sound source solely a center channel signal component corresponding to said center speaker not found in said speaker system, and to mix the gain-controlled center channel signal component with a left channel signal component and a right channel signal component corresponding to said left channel and said right channel respectively, carrying out the down-mixing process for output through said speaker system.

7. An audio apparatus comprising:
a decoding device configured to decode results of channel-by-channel reproduction of a multichannel sound source and to down-mix the decoded results of channel-by-channel reproduction in accordance with the number of speakers configured in a speaker system;
an audio processing device configured to perform predetermined audio processing on said decoded results having undergone the down-mixing by said decoding device, and to get the processed results output from said speaker system; and
a control device configured to control said audio processing device;
wherein said control device causes said decoding device to decode said results of channel-by-channel reproduction of the sound source, without performing said down-mixing in accordance with the number of speakers configured in said speaker system; and
said control device causes said audio processing device to gain-control within said sound source solely a particular channel signal component corresponding to a particular speaker not found in said speaker system, and to mix the gain-controlled particular channel signal component with the other channel signal components of said sound source, carrying out the down-mixing process for output through said speaker system.
